(19) United States
(12) Patent Application Publication
(10) Pub. No.: US 2004/0218201 A1
(43) Pub. Date: Nov. 4, 2004

(54) Methods and apparatus for dynamically configuring cluster printing systems

(76) Inventors: Pierre Lermant, Sunnyvale, CA (US); Nick Hartzel, Stillwater, MN (US)

Correspondence Address: JAMES TROSINO, 268 Bush Street #3434, SAN FRANCISCO, CA, 94104, US

(21) Appl. No.: 10/426,982

(22) Filed: Apr. 30, 2003

(51) Int. Cl. G06F 15/00

(52) U.S. Cl. 358/1.13; 358/1.15

(57) ABSTRACT

Methods and apparatus are provided for configuring a cluster printing system that includes a virtual printer cluster having multiple printers, the methods and apparatus dynamically displaying a list of the eligible printers based on a print job feature selection, and dynamically displaying a list of available features based on a printer selection.

### FIELD OF THE INVENTION

This invention relates to digital printing, and more particularly to cluster printing systems.

### BACKGROUND

In the past few years, the print industry has experienced rapid change with regard to the way that print jobs are printed. Not long ago, a print job could be printed by sending the job to a single print output device, and the entire job would be printed on that individual device. Thus, for example, if a print job included a 100 page document, the entire document would be sent to a single printer for printing. As technology evolved, print controllers were developed that could split a job between multiple “identical” printers (i.e., printers that were of the same make and model) to increase overall throughput. Thus, in the previous example, if the print job were provided to a print controller coupled to two identical printers, one printer could print pages 1-50, and the other printer could print pages 51-100, effectively doubling the throughput.

More recently, print technology has advanced to provide “cluster printing,” in which multiple printers may be coupled together in a network. In particular, cluster printing systems may be used to couple multiple printers together to form “virtual printers.” One exemplary cluster printing system is Velocity™ workflow software, licensed by Electronics for Imaging, Inc., Foster City, Calif. Velocity software may be used to couple many printers together, regardless of brand and model, to appear as a single virtual printer group on a network. Velocity software can load balance a single “long” print job among multiple printers, split color from black-and-white pages in the same document, route a print job to the best available printer based on the number of pages and other characteristics, send a print job to an alternate printer if a currently selected printer is out of paper or toner or if there is a paper jam, and automatically send certain types of jobs to specific printers, based on specified criteria such as media characteristics, finishing options and device capabilities.

Referring to FIG. 1, an exemplary previously known cluster printing system is described. Cluster printing system 10 includes one or more client devices 12 that are coupled to server 18 directly (e.g., client 12a), or via network 16 (e.g., clients 12b, 12cand 12d). Server 18 also is coupled to one or more printers 22 via network 20. Client devices 12 may be personal computers, laptop computers, handheld computers, computer workstations, personal digital assistants, cell-phones, fax machines, or any similar device that may be used to provide print jobs 14 for printing. Networks 16 and 20 each may be a local area network, wide area network, wireless network, the Internet, or any similar network. Networks 16 and 20 each may be a single network or may include multiple networks, and the two networks may be the same network. Server 18 may be a personal computer, laptop computer, handheld computer, computer workstation or any similar device that includes software and/or hardware that provides cluster printing capabilities. Printers 22 may be one or more printers, copiers, fax machines, laser printers, plotters, inkjet printers, wide format printers, or other similar printers that may be used to provide print output 24. Printers 22 may be the same make and model, or may include more than one make and model of printer.

Server 18 typically includes cluster printing hardware and/or software that may be used to create one or more virtual printer groups. In some previously known systems, a user of any of client computers 12, such as client computer 12a, may create virtual printer clusters that include various combinations of printers 22. For example, printer 22a may be a 12 page per minute (“ppm”) black and white (“b&w”) printer, printer 22b may be a 100 ppm b&w printer, printer 22c may be a 32 ppm color printer, and printer 22d may be an 80 ppm color printer. Thus, a first virtual printer cluster may be created that includes printers 22a and 22c, a second virtual printer cluster may be created that includes printers 22b, 22c and 22d, a third virtual printer cluster may be created that includes printers 22b and 22d, and so on. Once the virtual printer clusters have been created, the user may then send print jobs, such as print job 14a, to any of the virtual printer clusters using an application program such as a word processing program, spreadsheet program, presentations program, job downloading tool or any other similar program.

Once a user has selected a desired virtual printer cluster, server 18 may be used to route print job 14a to specific printers 22 within a selected cluster based on various print job parameters. For example, if a selected virtual printer cluster includes printers 22a-22d, server 18 can select which of the printers to send print job 14a or parts of print job 14a according to print options included in the job request. Thus, if print job 14a requests duplex printing, then server 18 may render all printers 22a-22d that are incapable of duplex printing as ineligible for the job. Also, server 18 may send color pages to color printers and black and white pages to black and white printers, load balance print jobs based on cost versus image quality, and perform dynamic load-balancing, by keeping track of the current load of the attached printers and routing jobs to printers that are the less busy or that have the fastest throughput.

In addition, once a user has selected a desired virtual printer cluster, previously known cluster printing systems typically provide the user with a “superset” of all printing features that may be performed by the printers in the virtual printer cluster. Thus, for example, a virtual printer cluster may be selected that includes printers 22a-22d, with the following features:

| | | | Single | Double | Booklet |
|---|---|---|---|---|---|
| Printer | Color | Duplex | Staple | Staple | Imposition |
| 22a | | | X | | X |
| 22b | | X | | | |
| 22c | X | | X | X | |
| 22d | X | X | X | | X |

In this example, the superset of all printing features includes color printing, duplex printing, single stapling, double stapling and booklet imposition.

Although the virtual printer cluster in the above example provides a wide range of print features, some combinations of print features may not be provided by any single printer in the cluster. For example, if a user submits a print job and selects color printing, duplex printing, and double stapling, no printer in the virtual printer cluster is capable of completing the requested features. Nevertheless, previously known cluster printing systems typically do not provide users with information about which printers in the virtual printer cluster can print a print job before the user submits the print job. In the example described above, the user typically will not know that the print job cannot be printed as requested until after the job has been submitted, causing wasted time and frustration for the user. In addition, for a given set of selected print job options, previously known cluster printing systems do not dynamically inform the user of the subset of printers within the cluster that could render all of the selected options.

Further, previously known cluster printing systems typically do not permit a user to select a subset of printers within the virtual printer cluster to which server 18 will distribute a print job. For example, in the exemplary virtual printer cluster described above, printers 22c and 22d both provide color printing. Although both printers may be used for color printing, a user may want to use only one of the printers for a particular color print job. Previously known cluster printing systems , however, typically do not permit a user to select a specific printer within the virtual printer cluster to print the job.

In view of the foregoing, it would be desirable to provide cluster printing methods and apparatus that allow a user to select an individual printer or group of printers within a selected virtual printer cluster for printing a print job.

It further would be desirable to provide cluster printing methods and apparatus that provide information to a user about print features that each printer or group of printers in a selected virtual printer cluster can provide, before the user submits the print job.

It additionally would be desirable to provide cluster printing methods and apparatus that allow a user to select an individual printer or group of printers within a selected virtual printer cluster and provide information to a user about print features that each selected printer or group of printers within a printer cluster can provide, before the user submits the print job.

### SUMMARY

In view of the foregoing, it is an object of this invention to provide cluster printing methods and apparatus that allow a user to select an individual printer or group of printers within a selected virtual printer cluster for printing a print job

It further is an object of this invention to provide cluster printing methods and apparatus that provide information to a user about print features that each printer or group of printers in a selected virtual printer cluster can provide, before the user submits the print job.

It additionally is an object of this invention to provide cluster printing methods and apparatus that allow a user to select an individual printer or group of printers within a selected virtual printer cluster and provide information to a user about print features that each selected printer or group of printers within a printer cluster can provide, before the user submits the print job.

These and other objects of this invention are accomplished by providing methods and apparatus that dynamically display a list of the eligible printers based on a user's print job feature selection, and dynamically display a list of available features based on a user's printer selection.

### BRIEF DESCRIPTION OF THE DRAWINGS

The above-mentioned objects and features of the present invention can be more clearly understood from the following detailed description considered in conjunction with the following drawings, in which the same reference numerals denote the same elements throughout, and in which:

FIG. 1 is a block diagram of a previously known cluster printing system;

FIG. 2 is block diagram of an exemplary method in accordance with this invention;

FIG. 3 is a diagram of an exemplary feature list in accordance with this invention;

FIG. 4 is a diagram of an exemplary user interface in accordance with this invention;

FIG. 5 is a diagram of the user interface of FIG. 4 with the “Cluster Printers” field selected;

FIG. 6 is a diagram of the user interface of FIG. 5 with the “Preferred Printer” subfield selected; and

FIG. 7 is a diagram of the user interface of FIG. 5 with the “Printer Location” subfield selected.

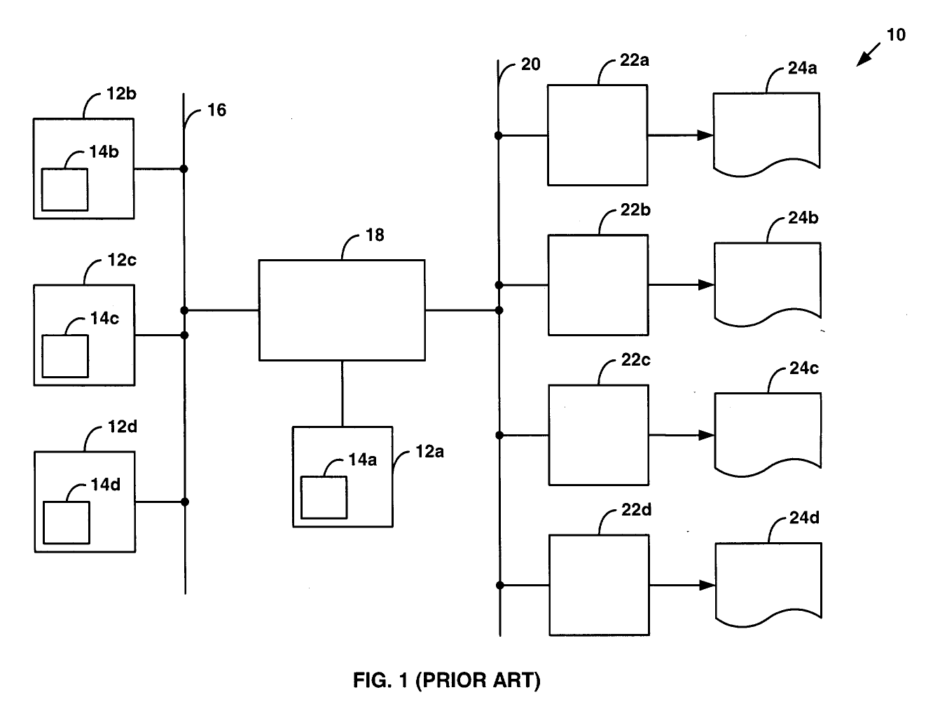

### DETAILED DESCRIPTION

The present invention provides methods and apparatus for dynamically providing printer feature information for a cluster printing system that includes multiple printers. As used herein, the term “printer” will refer to any print output device, such as printers, print controllers, copiers, fax machines, or other similar print output devices.

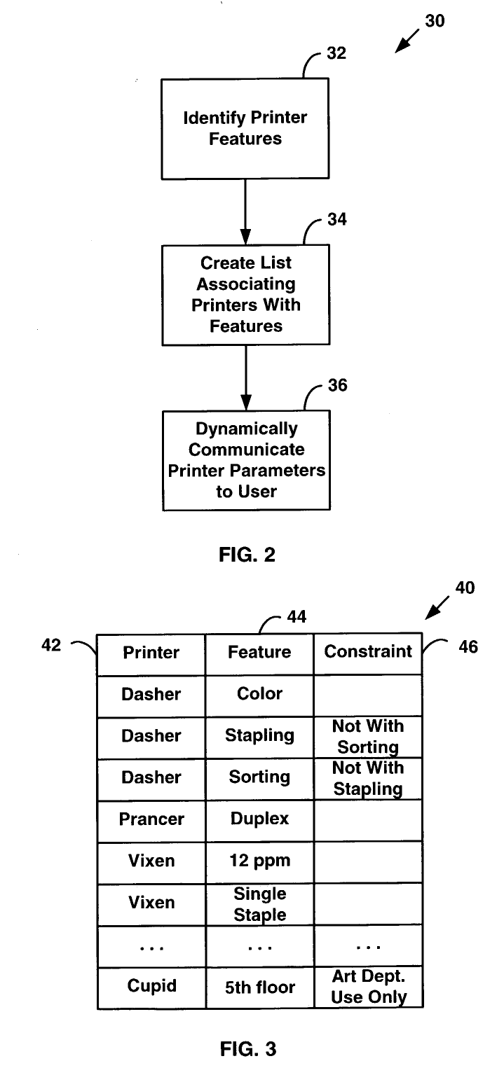

Referring to FIG. 2, an exemplary method in accordance with this invention is described. Exemplary method 30 begins with step 32, in which the features of each printer in a virtual printer cluster are identified. For each printer in the virtual printer cluster, information pertaining to the printer is identified for use by the cluster printing system. For example, the printer's performance features, such as rated speed, color capability, finishing options, and other similar features are identified. In addition, other features about the printer may be identified, such as location, cost per copy, restrictions on use, and other similar features. Alternatively, any constraints associated with the printer features also may be identified for use by the cluster printing system. For example, a particular printer may provide stapling and sorting, but may not be able to simultaneously provide both stapling and sorting.

A system administrator may identify the features of each printer in a virtual printer cluster, and may provide each identified feature to the cluster printing system via a user interface. Alternatively, the cluster printing system may be programmed to extract the features of each printer in the cluster directly from the printer. For example, the cluster printing system may parse the printer's PostScript printer description (“PPD”) file for features. Otherwise, the cluster printing system may query the printer for feature information using a protocol such as simple network management protocol (“SNMP”) or Internet printing protocol (“IPP”). Alternatively, the cluster printing system may be programmed to extract the features from the printer's print driver, which typically may be freely downloaded from the printer manufacturer's Internet Web site. In each of these examples, any constraints associated with the identified features also may be provided to the cluster printing system.

Next, at step 34, the cluster printer system creates a list associating indicia identifying each printer in the virtual printer cluster with the printer's features identified in step 32. Referring now to FIG. 3, an exemplary list in accordance with this invention is described. List 40 includes a first column 42 for specifying printer name, and a second column 44 for specifying the features of the named printer. Thus, the printer “Dasher” includes color, stapling and sorting features, whereas the printer “Prancer” includes a duplex feature. List 40 also may include a third column including constraints on the features. For example, the printer “Dasher” includes stapling and sorting features, but the printer cannot simultaneously support both features. Persons of ordinary skill in the art will understand that indicia other than a name may be used to identify each printer in the virtual printer cluster. For example, lists in accordance with this invention may associate a printer's network address with the printer's features and any associated constraints. For simplicity, the remaining description refers to the indicia as “printer name.” In addition, the remaining discussion refers to the combination of a printer name, feature and any associated constraint as a “Printer Parameter.”

Persons of ordinary skill in the art will understand that lists in accordance with this invention may include more than or less than three columns, and may be organized in formats other than as shown in FIG. 3. For example, some previously known cluster printing systems create a unique PPD file for each virtual printer cluster in the system. As an alternative to the list format of FIG. 3, cluster printing systems in accordance with this invention may use the PPD for the virtual printer cluster to associate printer names, features and constraints for the printers in the cluster. For example, the Printer Parameters for each printer in a cluster may be included in comment fields in the PPD file.

Alternatively, cluster printing systems in accordance with this invention may implement industry-standard specifications for describing print job processing, such as a job description format (“JDF”) specification. As a result, the Printer Parameters of each printer in a virtual printer cluster may be described in accordance with the JDF specification. For example, the Printer Parameters may be included as part of a JDF environment setup, or other similar format within the context of the JDF specification.

Referring again to FIG. 2, at step 36, the Printer Parameters from the list created in step 34 are then dynamically communicated to a user. For example, if a user of client computer 12a wants to submit print job 14a to a virtual printer cluster via a word processor application on client computer 12a, a user interface may display the list of printers included in the virtual printer cluster, and the superset of features that the virtual printer cluster supports. The user interface may be provided, for example, by a virtual printer driver application on client computer 12a. If the list of Printer Parameters are included in a PPD file for the virtual printer cluster, the driver application may parse the PPD file to extract the information from the file, and then provide the information to the user. As described in more detail below, the user interface allows the user to choose print job options and specific printers in the virtual printer for printing a print job, and dynamically changes to reflect the available printers and features that may satisfy the user's request.

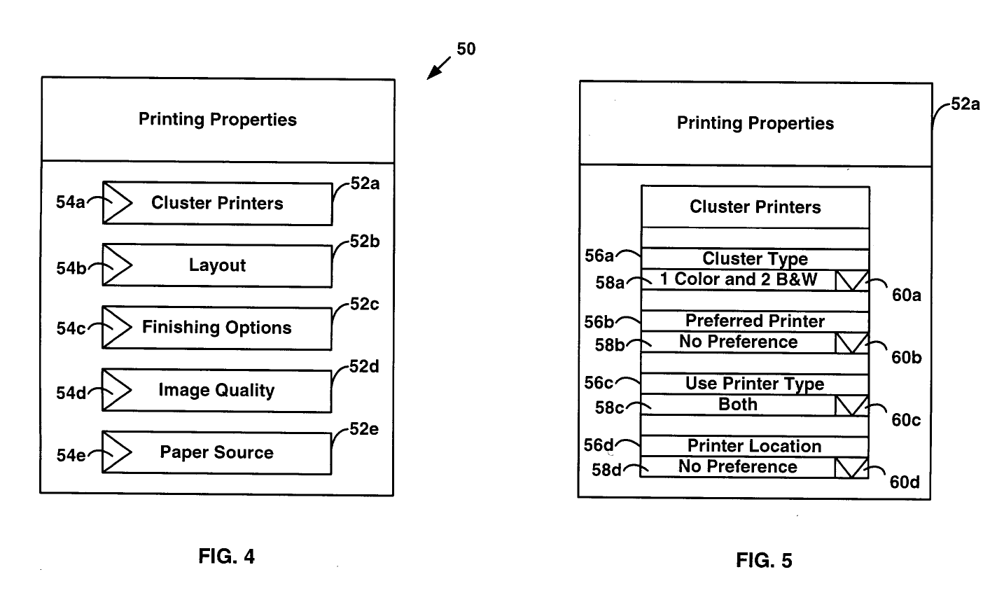

Referring to FIG. 4, an exemplary user interface display in accordance with this invention is described. User interface 50 includes user-selectable fields 52a-52e that provide print job options for the virtual printer cluster. For example, field 52a may include options regarding the printers included in the virtual printer cluster, field 52b may include layout options for the print job, field 52c may include finishing options for the print job, field 52d may include output image quality options, and field 52e may include paper source options. Persons of ordinary skill in the art will understand that user interface 50 is for illustrative purposes only, and that other user interface displays and other user-selectable fields may be used.

As a user selects any of selection tabs 54a-54e of user-selectable fields 52a-52e, a corresponding drop-down window of field-specific options may be displayed. For example, FIG. 5 illustrates an exemplary user interface display after Cluster Printers field 52a is selected. Cluster Printers field 52a includes user-selectable subfields “Cluster Type” 56a, “Preferred Printer” 56b, “Use Printer Type” 56c and “Printer Location” 56d. Subfields 56a-56d optionally may include current value areas 58a-58d, respectively, showing the currently selected value of each subfield. Thus, in the illustrative display, Cluster Type 56a has a current value of “1 Color and 2 B&W,” and Preferred Printer 56b has a current value of “No Preference.” Persons of ordinary skill in the art will understand that display 52a is for illustrative purposes only, and that other user-selectable subfields may be used.

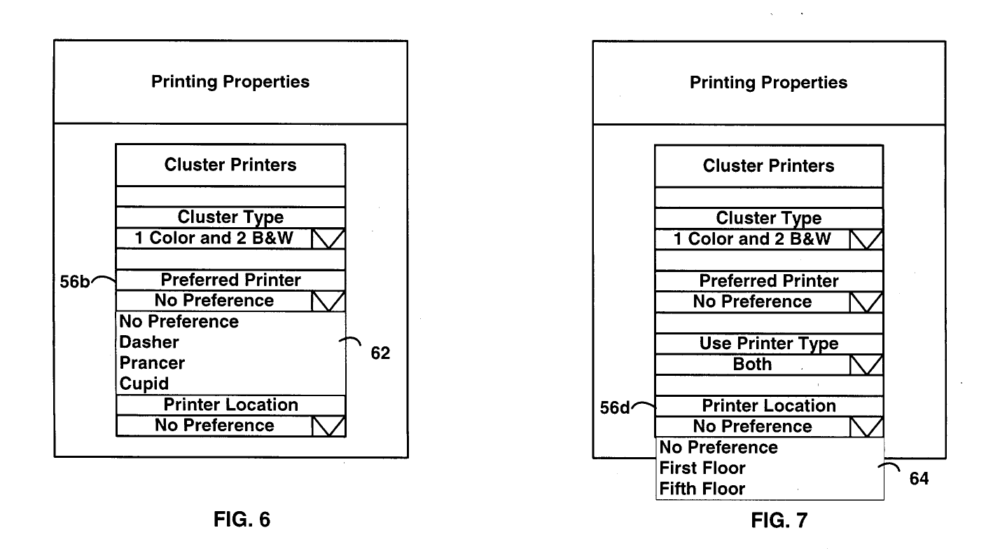

As a user selects any of selection tabs 60a-60d of user-selectable subfields 56a-56d, respectively, a corresponding drop-down window of specific options may be displayed. For example, FIG. 6 illustrates an exemplary user interface display after Preferred Printer subfield 56b is selected. Preferred Printer subfield 56b may be used to select a printer from within the virtual printer cluster that is a user's preference for receiving printed output. Drop down window 62 includes the following user-selectable choices: “No Preference,” “Dasher,” “Prancer,” and “Cupid.” Thus, for example, a user may select the printer “Dasher” as a preferred printer because that printer is closest to the user's work area. Preferred Printer subfield 56b may limit a user's choice to an individual preferred printer, or may allow a user to select more than one preferred printer. Thus, by using the “Preferred Printer” subfield, a user may create a “mini-cluster” that is a subset of the printers in the virtual printer cluster.

FIG. 7 illustrates an exemplary user interface display after Printer Location subfield 56d is selected. Printer Location subfield 56d may be used to select a printer location from within the virtual printer cluster that is a user's preference for receiving printed output. Drop down window 64 includes the following user-selectable choices: “No Preference,” “First Floor,” and “Fifth Floor.” Thus, for example, a user may select the Fifth Floor as a preferred printer location because the user works on that floor. Printer Location subfield 56d may limit a user's choice to an individual printer location, or may allow a user to select more than one printer location.

Referring again to FIGS. 4-7, a user therefore may make print job option and specific printer selections by variously selecting user-selectable fields 52a-52e, and corresponding subfields and options. In accordance with this invention, as a user makes job option selections (e.g., Stapling and Fifth Floor) the driver application informs the user of the printers within the virtual printer cluster that can produce all or parts of the job. Thus, for example, a virtual printer cluster may include one printer on the First Floor, and two printers on the Fifth Floor, with neither Fifth Floor printer supporting Duplex Printing. If a user first selects the Fifth Floor in Printer Location field 56d, user interface 50 will update other option fields as necessary in accordance with the user's selection. In this example, therefore, the Duplex Printing option will no longer be available for selection from Finishing Options field 52c (e.g., the option may be removed from the list, or may be grayed-out, or may be made unavailable using any other similar technique).

Alternatively, if a user first selects Duplex Printing from Finishing Options filed 52c, the option for selecting the Fifth Floor will no longer be available for selection from Cluster Printers field 52a. If a user selects a combination of options that no printer can provide, the driver application may display a warning message informing the user that his job cannot be printed as currently specified. In addition, the driver application may suggest a set of possible actions, like de-selecting or modifying options, until the set of eligible printers for the given job includes at least one device.

Similarly, if a user selects a specific printer (e.g., “Dasher”) as a preferred printer via Cluster Printers field 52a, user interface 50 will only display the options that the selected printer can provide. Thus, if Dasher is a color printer located on the First Floor, but that does not include duplex printing capability, the option for selecting the Fifth Floor will no longer be available for selection from Cluster Printers field 52a, and Duplex Printing will no longer be available for selection from Finishing Options field 52c. If Cluster Printers field 52 permits a user to specify more than one preferred printer, user interface 50 will display only the options that all of the selected printers can provide.

Exemplary apparatus for implementing at least some aspects of this invention include a general purpose computing device, such as a personal computer, and a server computer, such as a server used in cluster printing systems. Such computing devices may include a computer memory such as read only memory, hard disk, magnetic disk, optical disk, or other suitable memory that may be used to store software modules and other data, such as feature tables, PPD files, JDF files, or other similar files used to implement methods of the present invention.

Persons of ordinary skill in the art further will recognize that methods and apparatus in accordance with this invention may be implemented using steps or devices other than those shown and discussed above. All such modifications are within the scope of the present invention, which is limited only by the claims that follow.

We claim:

1. A method for configuring a cluster printing system that comprises a virtual printer cluster comprising a plurality of printers, each of the printers comprising identifying indicia, the method comprising:
identifying a feature of one of the printers;
creating a list associating the identified feature with the indicia of the printer;
dynamically communicating the listed feature and the associated indicia to a user of the cluster printing system.

2. The method of claim 1, wherein identifying further comprises providing the feature to the cluster printing system using a user interface.

3. The method of claim 1, wherein identifying further comprises extracting the feature from the printer.

4. The method of claim 1, wherein identifying further comprises parsing the feature from a PostScript printer description (“PPD”) file.

5. The method of claim 1, wherein identifying further comprises querying the printer for the feature.

6. The method of claim 1, wherein identifying further comprises extracting the feature from a print driver.

7. The method of claim 1, wherein the list comprises a table.

8. The method of claim 1, wherein the list comprises a PostScript printer description (“PPD”) file.

9. The method of claim 1, wherein the list is described in accordance with a job description file (“JDF”) specification.

10. The method of claim 1, wherein dynamically communicating further comprises communicating the feature using a virtual printer driver application.

11. The method of claim 10, wherein the virtual printer cluster comprises a PostScript printer description (“PPD”) file, and wherein the driver application parses the PPD file to extract the feature.

12. The method of claim 1, wherein dynamically communicating further comprises communicating the feature using an application comprising a user interface.

13. The method of claim 1, wherein dynamically communicating further comprises receiving a print job option selection.

14. The method of claim 13, wherein dynamically communicating further comprises providing a list of the indicia of the printers that can handle all or parts of the print job.

15. The method of claim 13, wherein the print job option selection comprises a print job feature.

16. The method of claim 13, wherein the print job option selection comprises a printer indicia.

17. A method for configuring a cluster printing system that comprises a virtual printer cluster comprising a plurality of printers, each of the printers comprising identifying indicia, the method comprising:
identifying a plurality of features of one of the printers;
creating a list associating the identified features with the indicia of the printer;
dynamically communicating the list features and the associated indicia to a user of the cluster printing system.

18. The method of claim 17, wherein identifying further comprises providing the features to the cluster printing system using a user interface.

19. The method of claim 17, wherein identifying further comprises extracting the features from the printer.

20. The method of claim 17, wherein identifying further comprises parsing the features from a PostScript printer description (“PPD”) file.

21. The method of claim 17, wherein identifying further comprises querying the printer for the features.

22. The method of claim 17, wherein identifying further comprises extracting the features from a print driver.

23. The method of claim 17, wherein the list comprises a table.

24. The method of claim 17, wherein the list comprises a PostScript printer description (“PPD”) file.

25. The method of claim 17, wherein the list is described in accordance with a job description file (“JDF”) specification.

26. The method of claim 17, wherein dynamically communicating further comprises communicating the features using a virtual printer driver application.

27. The method of claim 26, wherein the virtual printer cluster comprises a PostScript printer description (“PPD”) file, and wherein the driver application parses the PPD file to extract the features.

28. The method of claim 17, wherein dynamically communicating further comprises communicating the features using an application comprising a user interface.

29. The method of claim 1, wherein dynamically communicating further comprises receiving a print job option selection.

30. The method of claim 29, wherein dynamically communicating further comprises providing a list of the indicia of the printers that can handle all or parts of the print job.

31. The method of claim 29, wherein the print job option selection comprises a print job feature.

32. The method of claim 29, wherein the print job option selection comprises a printer indicia.

33. A method for configuring a cluster printing system that comprises a virtual printer cluster comprising a plurality of printers, each of the printers comprising identifying indicia, the method comprising:
identifying a feature of each of the printers;
creating a list associating the identified feature of each printer with the indicia of the printer;
dynamically communicating the listed features and associated indicia to a user of the cluster printing system.

34. The method of claim 33, wherein identifying further comprises providing the features to the cluster printing system using a user interface.

35. The method of claim 33, wherein identifying further comprises extracting the features from the printer.

36. The method of claim 33, wherein identifying further comprises parsing the features from a PostScript printer description (“PPD”) file.

37. The method of claim 33, wherein identifying further comprises querying the printer for the features.

38. The method of claim 33, wherein identifying further comprises extracting the features from a print driver.

39. The method of claim 33, wherein the list comprises a table.

40. The method of claim 33, wherein the list comprises a PostScript printer description (“PPD”) file.

41. The method of claim 33, wherein the list is described in accordance with a job description file (“JDF”) specification.

42. The method of claim 33, wherein dynamically communicating further comprises communicating the features using a virtual printer driver application.

43. The method of claim 42, wherein the virtual printer cluster comprises a PostScript printer description (“PPD”) file, and wherein the driver application parses the PPD file to extract the features.

44. The method of claim 33, wherein dynamically communicating further comprises communicating the features using an application comprising a user interface.

45. The method of claim 33, wherein dynamically communicating further comprises receiving a print job option selection.

46. The method of claim 45, wherein dynamically communicating further comprises providing a list of the indicia of the printers that can handle all or parts of the print job.

47. The method of claim 45, wherein the print job option selection comprises a print job feature.

48. The method of claim 45, wherein the print job option selection comprises a printer indicia.

49. A user interface for configuring a cluster printing system that comprises a virtual printer cluster comprising a plurality of printers, each of the printers comprising identifying indicia and a feature, the user interface comprising:
a first user-selectable list of the indicia of the printers; and
a second user-selectable list of the features, wherein the first and second user-selectable lists are dynamically modified as a user makes selections from the lists.

50. The user interface of claim 49, wherein the user interface comprises a printer driver application.

51. The user interface of claim 49, wherein the user interface comprises a virtual printer driver application.

52. A computer program for use with a cluster printing system that comprises a virtual printer cluster comprising a plurality of printers, each of the printers comprising identifying indicia, the computer program configured to:
identify a feature of one of the printers;
create a list associating the identified feature with the indicia of the printer;
dynamically communicate the listed feature and the associated indicia to a user of the cluster printing system.

53. A cluster printing system comprising:
a virtual printer cluster comprising a plurality of printers, wherein each of the printers comprises a feature and identifying indicia;
a server computer coupled to the printers, the server computer comprising cluster printing software and a list associating the feature of each of the printers with the indicia of the printer;
a client computer coupled to the server, the client computer comprising an application program, the application programmed to dynamically communicate the list of features and associated indicia.
